(19) United States
(12) Patent Application Publication
(10) Pub. No.: US 2013/0047108 A1
(43) Pub. Date: Feb. 21, 2013

(54) METHODS AND SYSTEMS FOR MANAGING AN ELECTRIC GRID THROUGH A DASHBOARD

(71) Applicants: Andrew Nelson Williams, Melbourne, FL (US); Shobhit Mehta, Melbourne, FL (US); Michael Todd Swanson, Melbourne, FL (US)

(72) Inventors: Andrew Nelson Williams, Melbourne, FL (US); Shobhit Mehta, Melbourne, FL (US); Michael Todd Swanson, Melbourne, FL (US)

(21) Appl. No.: 13/211,634

(22) Filed: Aug. 17, 2011

(51) Int. Cl. G06F 3/048

(52) U.S. Cl. 715/769; 715/771

(57) ABSTRACT

Methods and systems for managing an electric grid are described. One example method includes displaying a dashboard to a user via a computing assembly. The dashboard defines at least two cells. The example method includes receiving, at an input device of the computing assembly, a selection of a first module and appending the first module to a first of the at least two cells of the dashboard. The first module is configured to display, via the display device, at least one of electric grid data and a control to configure the electric grid.

### BACKGROUND OF THE INVENTION

The embodiments described herein relate generally to electric power generation and delivery systems and, more particularly, to systems and methods for use in managing a utility network through a dashboard.

Power generated by an electric utility typically is delivered to a customer via an electric grid. The electric power generation and delivery system is closely monitored and controlled by an electric grid control system, that includes a large number of individual subsystems, which may also include multiple components. Typically, information is transmitted from many of the subsystems/components to the control system for use in controlling operation of the electric grid. For example, some power utilities utilize what is referred to as a “smart grid.”

Known smart grids include a plurality of components and subsystems that communicate with a central management system, typically located at the utility. The components and subsystems may be distributed at various points in the utility network to facilitate power distribution. Due at least in part to the large scale of a smart grid, and the quantity of individual component/subsystems that may be included in the smart grid, information at the management system for use in centralized management of the smart grid is generally expansive and complex. In general, users of the management system have to individually locate, select, and display each portion of target information to separate screens or windows. Accordingly, such data management systems may be cumbersome and/or time consuming.

### BRIEF DESCRIPTION OF THE INVENTION

In one aspect, a method for managing an electric grid through a dashboard is provided. The method includes displaying a dashboard to a user via a computing assembly. The dashboard defines at least two cells. The method includes receiving, at an input device of the computing assembly, a selection of a first module and appending the first module to a first of the at least two cells of the dashboard. The first module is configured to display, via the display device, at least one of electric grid data and a control to configure the electric grid.

In another aspect, a system for managing an electric grid is provided. The system includes a display device, a memory device including electric grid data, and a processor in communication with the display device and the memory device. The processor is programmed to display a dashboard comprising a plurality of cells, receive a plurality of selections, from at least one user, to select a plurality of modules, and append each of the plurality of modules to one of the dashboard cells. Each of the plurality of modules is configured to display at least a portion of the electric grid data and/or a control for the electric grid.

In another aspect, a computer program embodied on a computer readable medium for managing an electric grid is disclosed. The computer program includes at least one code segment for displaying a dashboard to a display device of a computing assembly. The dashboard defines at least two cells. The computer program includes at least one code segment for receiving a selection of a first module and appending the first module to one of said at least two cells of the dashboard. The first module is configured to display at least one of electric grid data and a control to configure the electric grid.

### BRIEF DESCRIPTION OF THE DRAWINGS

FIG. 1 is a block diagram of an exemplary electric power generation and delivery system.

FIG. 2 is a block diagram of an exemplary management system that may be used to manage the electric power generation and delivery system shown in FIG. 1.

FIG. 3 is a block diagram of an exemplary method that may be used to manage the electric power generation and delivery system shown in FIG. 1.

FIG. 4 illustrates an exemplary dashboard that may be used with the management system shown in FIG. 2.

### DETAILED DESCRIPTION OF THE INVENTION

The following detailed description illustrates exemplary embodiments of the invention by way of example and not by way of limitation. It is contemplated that the invention has general application to analytical and methodical embodiments of managing operation and maintenance of widely geographically diverse power assets in industrial, commercial, and residential applications.

Embodiments of the methods and systems described herein relate to managing a utility network using a computing assembly. The embodiments include a dashboard displayed to a display device of a computing assembly. The dashboard defines at least two cells. The embodiments receive, at an input device of the computing assembly, a selection of a first module, and append the first module to one of the at least two cells of the dashboard. The first module displays, via the display device, at least one of electric grid data and a control mechanism that enables the electric grid to be variably configured.

The methods and systems described herein may be implemented using computer programming or engineering techniques including computer software, firmware, hardware or any combination or subset thereof, wherein an exemplary technical effect may include at least one of: (a) displaying a dashboard to a display device of a computing assembly, wherein the dashboard defines at least two cells, (b) receiving, at an input device of the computing assembly, a selection of a first module, and (c) appending the first module to a first of the at least two cells of the dashboard. The first module is configured to display, via the display device, at least one of electric grid data and a control to configure the electric grid.

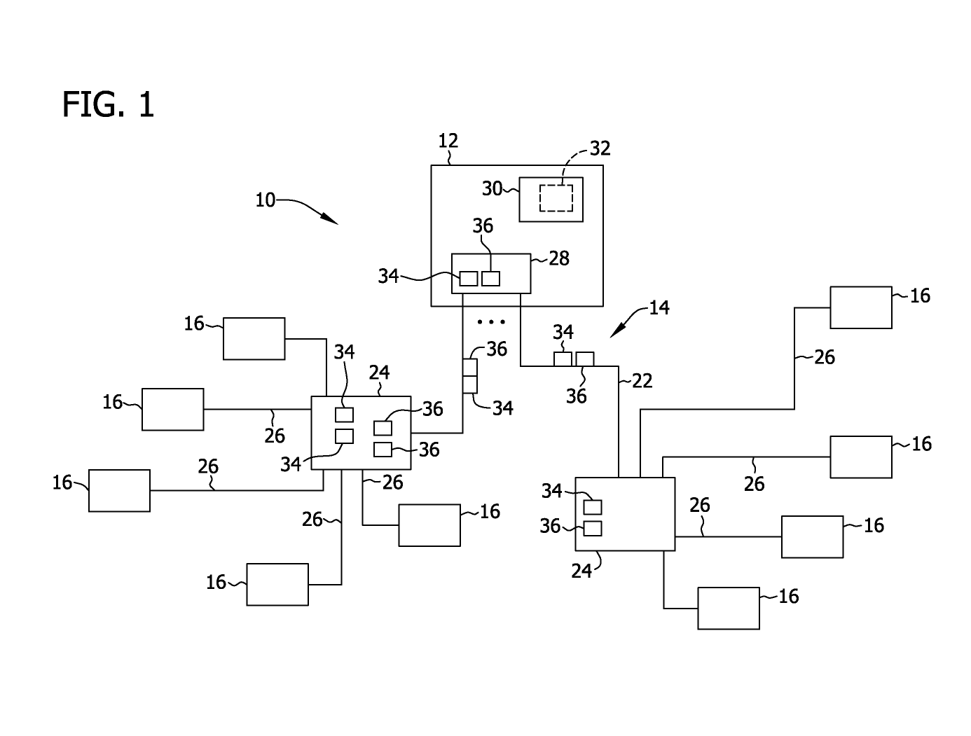

FIG. 1 is a block diagram of an exemplary electric power generation and delivery system 10. In the exemplary embodiment, electric power generation and delivery system 10 includes an electric utility 12, electric grid 14, and a plurality of customer or energy user locations 16. Moreover, in the exemplary embodiment, electricity is delivered from electric utility 12 to customer or energy user locations 16 via electric grid 14. More specifically, electric grid 14 includes a plurality of transmission lines 22, a plurality of electric substations 24, and a plurality of distribution lines 26 that enable distribution of electricity. Moreover, in the exemplary embodiment, electric utility 12 includes an electric power generation system 28 that supplies electrical power to electric grid 14. Electric power generation system 28 may include a generator driven by, for example, a gas turbine engine, a hydroelectric turbine, a wind turbine, one or more solar panels, and/or another suitable generation system.

In the exemplary embodiment, electric utility 12 also includes a distribution control center substation 30 that facilitates control of energy production and/or delivery. Distribution control center substation 30 is illustrated as being included within electric utility 12, however, distribution control center substation 30 may be external to electric utility 12 (e.g., remotely located, etc.) and in communication with electric utility 12.

In the exemplary embodiment, distribution control center substation 30 includes a management system 32 that provides operator control for managing power delivered from electric power generation system 28 and/or distributed into electric grid 14. Management system 32 may control distribution to electrical substations 24, to customer or energy user locations 16, and/or other suitable point within electric grid 14. Management system 32 may be usable to detect operating conditions in the electric grid 14, alter a configuration of grid 14, and/or other operations associated with electric grid 14 and/or electric power generation system 28. Specifically, in the exemplary embodiment, management system 32 is coupled to a plurality of indicators 34 and to switchable assets 36 distributed throughout system 10.

In one example, management system 32 may be employed to rapidly respond to outage/fault conditions to reconfigure to electric grid 14, via one or more switchable assets 36, in an effort to limit potential safety issues and/or damage to/from electric grid 14. In another example, to enable the installation of equipment or the replacement of existing equipment, a switch plan may be provided to safely de-energize a section of conductor prior to performing the work. Management system 32 may determine a switch plan and create a planned outage order associated with the switch plan. Management system 32 may also be configured to simulate the switch plan in order to ensure accuracy, safety, and effectiveness of the switch plan. The availability of work crews and tools necessary to perform a desired maintenance/repair may also be coordinated by management system 32. Specifically, management system 32 may be useable by a dispatcher or a network operator to dispatch work crews and tools to appropriate locations, and/or to coordinate switch plans to minimize impact on operation of electric grid 14.

In at least one embodiment, management system 32 may include a supervisory control and data acquisition (SCADA) component, such as the SCADA Energy Management System commercially available from General Electric Company. Specifically, management system 32 may include a user interface that enables a user, such as such as dispatcher, a network operator, utility engineer, a systems engineer, a transmission engineer, etc., to manage electric grid 14.

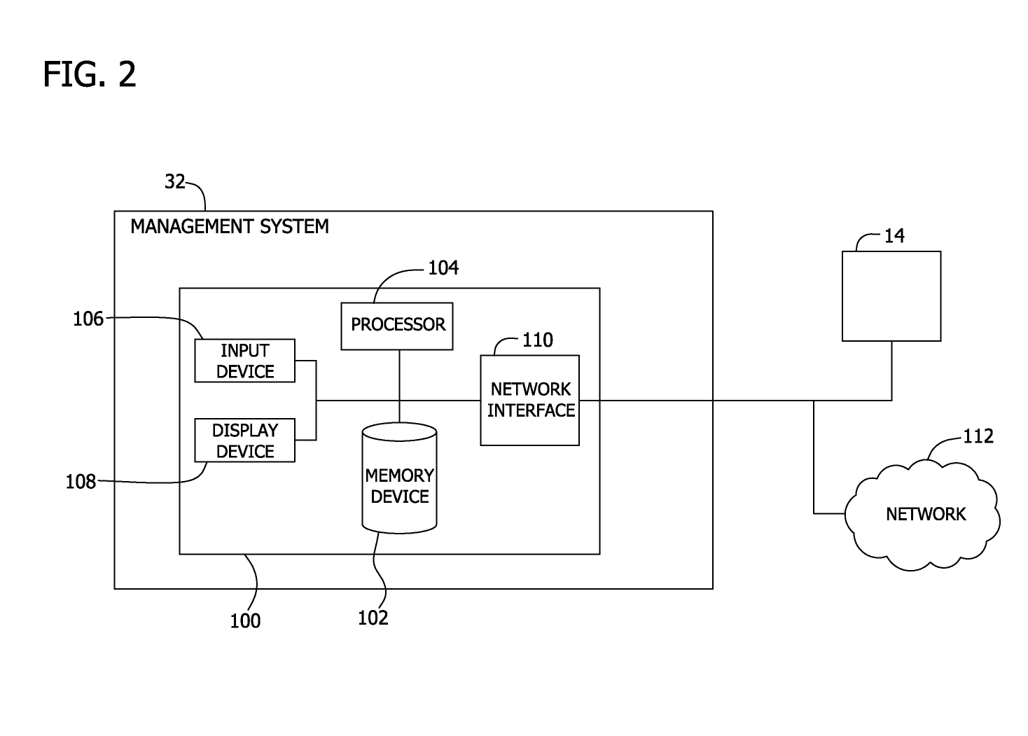

FIG. 2 is an exemplary block diagram of management system 32. In the exemplary embodiment, management system 32 includes a computing assembly 100. Computing assembly 100 may include a personal computer, a workstation, a server, a network computer, a mobile computer, a portable digital assistant (PDA), a smartphone, or other suitable device. As illustrated, computing assembly 100 includes a display device 108, a memory device 102 and a processor 104 in communication with display device 108 and memory device 102. Display device 108 may include, without limitation, a cathode ray tube (CRT) display, a liquid crystal display (LCD), an organic light emitting diode (OLED) display, or other suitable device for use in presenting information to a user.

Memory device 102 is any suitable device that may be used for storing and/or retrieving information, such as executable instructions and/or data. Memory device 102 may include any computer readable medium, such as hard disk storage, optical drive/disk storage, removable disk storage, flash memory, random access memory (RAM), etc. While memory device 102 is illustrated as a single element in FIG. 2, it should be appreciated that memory device 102 may include one or multiple separate memory devices, located together or remote from one another.

Processor 104 may include one or more processing units (e.g., in a multi-core configuration). The term processor, as used herein, refers to central processing units, microprocessors, microcontrollers, reduced instruction set circuits (RISC), application specific integrated circuits (ASIC), logic circuits, and any other circuit or processor capable of executing instructions. Processor 104 may be programmed to perform alone or in combination any of the processes, methods or functions described herein.

Computing assembly 100 includes an input device 106 for receiving input from user. Input device 106 may include, without limitation, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both display device 108 and input device 106. Further, the particular example embodiment of FIG. 2, computing assembly 100 includes a network interface 110. Network interface 110 may provide communication between computing assembly 100 and electric grid 14 and/or one or more public networks 112, such as Internet, Intranet, a local area network (LAN), a cellular network, a wide area network (WAN), etc.

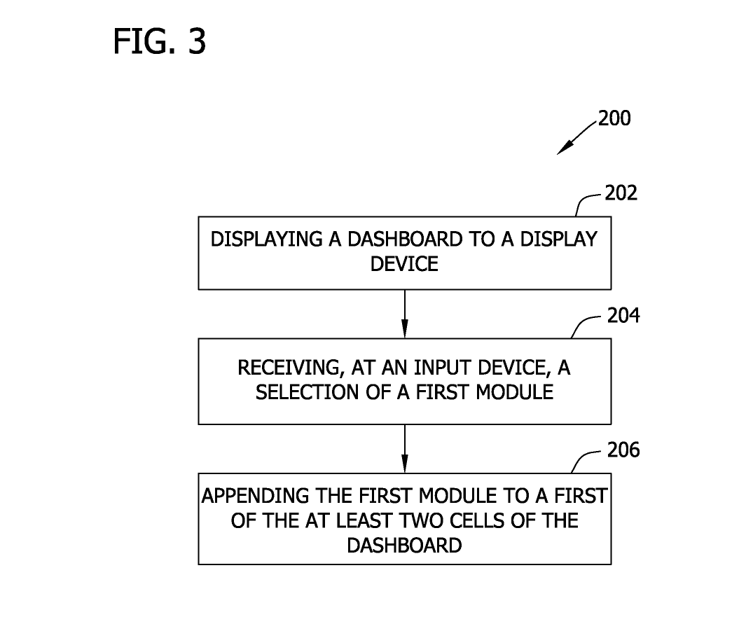

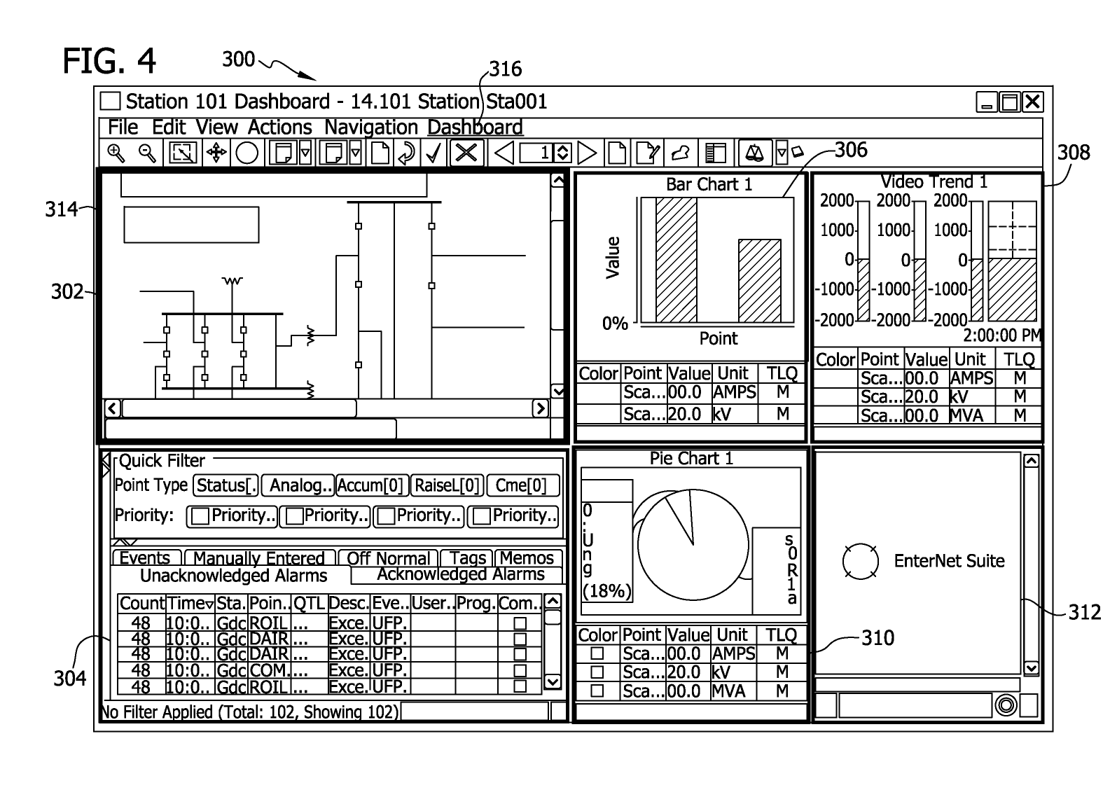

FIG. 3 is a block diagram of an exemplary method 200 for managing an electric grid to be managed through a dashboard, such as dashboard 300 as described below with reference to FIG. 4. Method 200 is described with reference to electric grid 14 and management system 32, and uses the same reference numbers used in FIGS. 1 and 2. It should be appreciated, however, that the methods described herein may be applied to a wide variety of electric grids and therefore are not limited to the configuration to electric grid 14 or management system 32. Likewise, electric grid 14 and management system 32 should not be understood to be limited to the methods disclosed herein.

Method 200 includes displaying 202 a dashboard via display device 108, wherein the dashboard defines at least two cells. Method 200 includes receiving 204, at input device 106, a selection of a first module, and appending 206 the first module to a first of the at least two cells of the dashboard. The first module displays, via the display device 201, at least one of electric grid data and/or a control mechanism that may be used to configure electric grid 14.

Accordingly, the dashboard may permit multiple sources of data and/or controls to be displayed in a single dashboard to a user for managing an electric grid. In this manner, a user is not required to search, elect and display one source of data or control individually, but may display multiple sources of information in a single dashboard at one time.

Electric grid data may be any information associated with electric grid 14. For example, a module may be configured to display electric grid data including, without limitation, violations, contingencies, alarms, losses, generation, loading, forecast, temperature, and/or reserve, etc. An example module may organize electric grid data by point/area of electric grid 14, time (e.g., daily peak load), category (e.g., losses by type or status of major programs), SCADA summaries, point condition summaries, device point summaries, and/or any other suitable ordering of information related to electric grid 14. Further, an example module may be configured to present the electric grid data in one or more lists, charts (e.g., Kiviat chart), graphs, diagrams, schematics, tables, drawings, video trends and charts, or other presentations suitable to inform the user of desired data. In one example, a module may be configured to display a transmission security management (TSM) application, one-line and/or world base displays.

Electric grid data may be real-time or estimated. For example, in the exemplary embodiment, electric grid 14 includes indicators 34 distributed throughout system 10. Indicators 34 may communicate real-time electric grid data to the computing assembly 100, which may be displayed to a user through one or more modules of a dashboard. Conversely, electric grid data may be estimated based on one or more proposed configurations of electric grid 14. In at least one embodiment, a module may be configured to display real-time and estimated electric grid data.

Additionally, or alternatively, a module may include one or more controls for electric grid 14. The controls may affect various aspects of electric grid 14, such as transmission channels, loading, switching, channel isolation, etc. The controls for electric grid 14 may be real-time or proposed. Referring to FIG. 1, for example, a module may include a control used for toggling one or more switchable assets 36, via network interface 110, in response to a user input to the module. Alternatively, in another example, a module may include a control used to enter one or more proposed configurations of electric grid 14.

It should be appreciated that any number of modules may be appended to a dashboard depending at least partially on the type of data and/or control desired by a user. In various example embodiments, methods described herein may include receiving, at input device 106, a selection of a second module and appending the second module to another one of said at least two cells of the dashboard. The second module may be configured to display, via display device 108, at least one of electric grid data and a control mechanism used to configure electric grid 14.

Further, the second module may receive, at input device 106, a proposed configuration of electric grid 14, and the first module may display, via display device 108, estimated electric grid data based on the proposed configuration of electric grid 14. The estimated electric grid data permits a user to view effects of one or more alterations to electric grid 14 in a single dashboard, without actually altering electric grid 14. In this manner, a user may propose a configuration to facilitate reducing transmission losses. In such a scenario, the user is able to utilize the dashboard to virtually implement the configuration of electric grid 14 to evaluate the transmission losses response to the configuration, without physically changing electric grid 14.

Moreover, the second module of the dashboard may receive, at input device 106, an implement command to alter electric grid 14 in accordance with the proposed configuration. Specifically, once the proposed configuration including one or more alterations has be evaluated by a user (by viewing data displayed in one or more other modules), the user may implement the proposed configuration through the second module of the dashboard.

Method described herein may include receiving, at input device 106, a selection of a third module and appending the third module to a cell of the dashboard. The third module may display, via display device 108, public network data. Public network data may include, without limitation, weather data, imagining data, map data, or other data related to directly or indirectly associated with electric grid 14.

One exemplary dashboard 300 consistent with the methods described herein is illustrated in FIG. 4. Dashboard 300 includes six cells and five modules 302, 304, 306, 308 and 310 (collectively referred to as modules 302-310). Each module 302-310 is appended to one of the cells, such that an extra cell 312 is left empty. Modules 302-310 display various types of electric grid data. Specifically, module 302 includes a schematic of electric grid 14 including switchable assist controls, and module 304 includes a listing of alarms from electric grid 14. Module 306 includes current and voltage measured at a selected point in electric grid 14, and module 308 includes measured real and reactive power at a selected point in electric grid 14. Module 310 includes graphical information about a selected point in electric grid 14.

It should be appreciated that any number of cells and/or any relative position or orientation of cells may be included in other dashboard embodiments. For example, a dashboard may define 2×2 or 4×4 cell layouts. In some embodiments, a layout setting may be selected based on user inputs. For example, a layout setting for dashboard 300 may be received through input device 106. The layout setting may be selected based on the type/amount of data and/or controls included in one of more of the modules of dashboard 300. Further, a user may alter a layout setting to merge cells, to re-size cells and/or to change the number/position of cells.

As shown in FIG. 4, module 302 is highlighted to signify that module 302 of dashboard 300 has been selected. In this particular embodiment, highlighted module 302 is circumscribed with a thick line 314, which may be colored blue, red, yellow, and/or any other color that visually distinguishes module 302 from the remainder of dashboard 300. In one example, highlighting module 302 is dashboard 300 is in response to a user input, at input device 106, selecting the module 302.

In the exemplary embodiment, a toolbar 316 of the dashboard 302 may be customized to offer one or more functions relevant to the highlighted module 302 (not shown). For example, functions relevant to handling an alarm may be excluded from a toolbar, when module 306 is configured to merely display a bar chart of current/voltage at a point in electric grid 14 is highlighted. Further, in the exemplary embodiment, a title of the highlighted modules 302 (“14.101 Station Sta001”) is displayed in the title bar of dashboard 300.

Once the modules 302-310 have been appended to dashboard 300, dashboard 300 may be stored in memory device 102. Once stored in memory device 102, dashboard 300 may be recalled. In some embodiments, an access parameter may be assigned to dashboard 300, when dashboard 300 is stored in memory device 102. The access parameter may indicate one or more users permitted to recall/retrieve/edit dashboard 300. Accordingly, multiple dashboards 300 may be stored in memory device 102 and accessible globally by any user of management system 32, or accessible to a smaller group of users, such as system or transmission engineers.

In various embodiments, a module may be appended to dashboard 300 during an edit mode or a run mode. When modules 302-310 are appended to dashboard 300 in edit mode, modules 302-310 may be saved with dashboard 300 to memory device 102. In contrast, when modules 302-310 are appended to dashboard 300 during a run mode, modules 302-310 may not be stored with dashboard 300. Specifically, in the exemplary embodiment illustrated in FIG. 4, a module has not been appended to cell 312, as indicated by “EnterNet Suite.” Accordingly, a module may be selected and appended to cell 312 in either edit mode or run mode. In one example, selection of a module may include a drag-and-drop input, at input device 106, selecting the module (not shown) from a list of modules and positioning the module over cell 312 of the dashboard 300.

When dashboard 300 is stored in memory device 102, however, only modules 302-310 added during edit mode will be stored with dashboard 300. In this manner, dashboard 300 is customizable to a particular user, without affecting dashboard 300 as stored in memory device 102. Dashboard 300 may be toggled between edit mode and run mode through an input to “Dashboard” toolbar 316. Accordingly, if a user decides to change dashboard 300 stored in memory device 102, the user can invoke edit mode and append/remove modules as desired, before storing the edited dashboard in memory device 102.

As described above, electric grid data may be real-time electric grid data. Real-time electric grid data may be refreshed in the dashboard at one or multiple different time intervals, such as 1 second, 10 seconds, 1 minute, 5 minutes, 1 hour, 1 day, etc. For example, methods described herein may include refreshing electric grid data displayed in module 302 at a first desired rate and refresh electric grid data displayed in module 310 at a second desired rate.

According to another embodiment, computer program embodied on a non-transitory, computer readable medium for managing an electric grid is provided. The computer program include at least one code segment for displaying a dashboard to a display device of a computing assembly. The dashboard defines at least two cells. The computer program includes at least one code segment for receiving a selection of a first module and appending the first module to a first of said at least two cells of the dashboard. The first module is configured to display at least one of electric grid data and a control to configure the electric grid.

The above-described embodiments of a method and system of managing electric grid operation and maintenance provides a cost-effective and reliable means for establishing accurate reliability metrics that can be used to improve utility resource allocations, ensure faster outage restorations, and provide an ability to optimize how crews are allocated and with what equipment More specifically, the methods and systems described herein may provide efficient viewing of information associated with an electric grid and/or control of the electric grid, as compared to known management systems. As a result, the method and system described herein facilitate managing electric grid operation and maintenance in a user-friendly, cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for managing an electric grid, said method comprising:
displaying a dashboard to a user via a computing assembly, wherein the dashboard defines at least two cells;
receiving, at an input device of the computing assembly, a selection of a first module; and
appending the first module to a first of the at least two cells of the dashboard, wherein the first module is configured to display, via a display device, at least one of electric grid data and a control to configure the electric grid.

2. The method of claim 1, wherein appending the first module to the first of the at least two cells comprises appending the first module configured to display real-time electric grid data to the first of the at least two cells.

3. The method of claim 1, further comprising:
receiving, at the input device, a selection of a second module; and
appending the second module to a second one of the at least two cells of the dashboard, wherein the second module is configured to display at least one of electric grid data and a control mechanism for use in configuring the electric grid.

4. The method of claim 3, wherein appending the second module to the second one of the at least two cells comprises appending the second module configured to receive, at the input device, a proposed configuration of the electric grid to the second one of the at least two cells; and
wherein appending the first module to the first of the at least two cells comprises appending the first module configured to display, via the display device, estimated electric grid data based on the proposed configuration of the electric grid.

5. The method of claim 4, wherein appending the second module to the second one of the at least two cells comprises appending the second module configured to receive, at the input device, an implement command to alter the electric grid in accordance with said proposed configuration to the second one of the at least two cells.

6. The method of claim 3, further comprising:
highlighting one of the first and second modules in response to a user input, to the input device, selecting said one of the first and second modules and assigning functions associated with said highlighted one of the first and second modules to a toolbar of the dashboard.

7. The method of claim 1, further comprising receiving, at the input device, a layout setting for the dashboard, wherein the layout setting indicates at least one of a number and a position of cells defined by the dashboard.

8. The method of claim 1, wherein receiving a selection of a first module comprises dragging-and-dropping the first module from a list of modules into the first of the at least two cells of the dashboard.

9. The method of claim 1, further comprising:
receiving, at the input device, a selection of a third module; and
appending the third module to a third one of said at least two cells of the dashboard, wherein the third module is configured to display data from a public network.

10. A system for use in managing an electric grid, said system comprising:
a display device;
a memory device including electric grid data; and
a processor in communication with said display device and said memory device, said processor programmed to:
display a dashboard comprising a plurality of cells to the display device;
receive a plurality of selections, from at least one user, to select a plurality of modules; and
append each of the plurality of modules to one of the dashboard cells, wherein each of the plurality of modules is configured to display at least a portion of the electric grid data and/or a control for the electric grid.

11. The management system of claim 10, wherein one of said plurality of modules is configured to display at least a portion of the electric grid data, and wherein said at least a portion of the electric grid data includes estimated electric grid data based on a proposed configuration of the electric grid.

12. The management system of claim 10, wherein said processor is programmed to display a list of selectable modules.

13. The management system of claim 10, wherein said processor is programmed to store the dashboard comprising the plurality of modules in said memory device.

14. The management system of claim 13, wherein said processor is programmed to assign an access parameter to the dashboard for indicating one or more users permitted to recall the dashboard from said memory device.

15. The management system of claim 13, wherein said processor is programmed to store, in said memory device, the dashboard comprising modules appended to the dashboard during an edit mode, but not modules appended to the dashboard during a run mode.

16. The management system of claim 10, further comprising a network interface in communication with said processor;
wherein the electric grid includes a plurality of switchable assets in communication with the management system, and wherein said processor is programmed to toggle at least one of the plurality of switchable assets, via said network interference, in response to a user input to one of the plurality of modules.

17. The management system of claim 10, wherein said processor is further programmed to refresh electric grid data displayed in one of the plurality of modules at a first desired rate and refresh electric grid data displayed in another one of the plurality of modules at a second desired rate.

18. A computer program embodied on a computer readable medium for managing an electric grid, said computer program comprising at least one code segment for:
displaying a dashboard to a display device of a computing assembly, the dashboard defining at least two cells;
receiving a selection of a first module; and
appending the first module to a first of said at least two cells of the dashboard, the first module configured to display at least one of electric grid data and a control to configure the electric grid.

19. The computer program of claim 18, further comprising at least one code segment for storing the dashboard including the first module in a memory device.

20. The computer program of claim 19, further comprising at least one code segment for assigning functions associated with the first module to a toolbar of the dashboard when the first module is highlighted.
